(19) United States
(12) Patent Application Publication
(10) Pub. No.: US 2015/0245595 A1
(43) Pub. Date: Sep. 3, 2015

(54) METHOD AND SYSTEM FOR MONITORING AND/OR CONTROLLING THE RESOURCE CONSUMPTION OF AN AGRICULTURAL PLANT

(71) Applicant: BIG DUTCHMAN INTERNATIONAL GMBH, Vechta (DE)

(72) Inventors: Henning Muller, Vechta (DE); Ralf Garberding, Vechta (DE); Christian Kalkhoff, Vechta (DE); Heinz Sudkamp, Vechta (DE); Friedrich Otto-Lubker, Vechta (DE); Bernd Meerpohl, Vechta (DE)

(21) Appl. No.: 14/427,006

(22) PCT Filed: Sep. 10, 2013
(86) PCT No.: PCT/EP2013/068670

§ 371 Date: Mar. 10, 2015

(30) Foreign Application Priority Data
Sep. 12, 2012 (DE) 10 2012 017 966.9

(51) Int. Cl. A01K 29/00; G05B 15/02

(52) U.S. Cl. CPC A01K 29/005; G05B 15/02

(57) ABSTRACT

The invention relates to a method and a system for monitoring and/or controlling the resource consumption of an agricultural plant for livestock farming and rearing, in particular of a livestock production business. The method according to the invention comprises the following steps: determining agriculture-specific operating parameters of the agricultural plant in a current time interval, wherein the operating parameters contain information on the animal population, structure, and climate determining a resource consumption of at least one consumer least one resource type of the agricultural plant in the current time interval by means of at least one metering device, determining the resource consumption per one or more of the operating parameters, and outputting a signal comprising the resource consumption per one or more of the operating parameters.

### CROSS-REFERENCE TO FOREIGN PRIORITY APPLICATION

The present application claims the benefit under 35 U.S.C. §119(b) of PCT/EP2013/068670, filed Sep. 10, 2013, which claims priority to German Application 102012017966.9, filed Sep. 12, 2012, entitled “Method and System for Monitoring and/or Controlling of the Resource Consumption of an Agricultural Plant.”

### FIELD OF THE INVENTION

The invention relates to a method and a system for monitoring and/or controlling the resource consumption of an agricultural plant for livestock farming and rearing, in particular of a livestock production business.

### BACKGROUND OF THE INVENTION

In the context of increasing scarcity and rising resources prices, such as water, gas or oil, as well as the aim to conserve these resources, various approaches have been developed to determine the resource requirements and in particular to avoid peak energy consumption. Such approaches are described, for example, in DE 198 58 218 B4, DE 199 34 543 B4, DE 100 14 431 C2, DE 195 46 711 A1, WO 2009/111686 A1, WO 2009/134222 A1, WO 2010/005429 A1, WO 2010/048316 A1 or WO 2010/144465 A1.

However, one of the disadvantages of these approaches is that their use for particular areas of application is either difficult or not at all possible and/or that they deliver unsatisfactory results. Particularly in the field of livestock farming and rearing, such as pig and chicken production, existing approaches have proved to be impractical, since they are, for example, too expensive and complex to install and operate, and/or do not lead to results useful in livestock farming and rearing. However, particularly in livestock production businesses, such as in pig and chicken fattening, monitoring and/or controlling the resource consumption is desirable.

It is therefore an object of the present invention to provide a method and a system for monitoring and/or controlling the resource consumption of an agricultural plant for livestock farming and rearing, in particular of a livestock production business, which eliminate or reduce one or more of the stated disadvantages. In particular, it is an object of the present invention to provide a method and a system for monitoring and/or controlling the resource consumption of an agricultural plant for livestock farming and rearing, in particular of a livestock production business, which are usable in such an agricultural area of application and can deliver adequate results.

### SUMMARY OF THE INVENTION

This object is achieved according to the invention by a method and a system for monitoring and/or controlling the resource consumption of an agricultural plant for livestock farming and rearing, in particular of a livestock production business, comprising the steps of determining agriculture-specific operating parameters of the agricultural plant in a current time interval, wherein the operating parameters include information concerning animal population (namely the number of animals), a structure (namely the number and size of barns of the agricultural plant), and climate (namely the temperature inside the agricultural plant), determining resource consumption of at least one consumer of at least one type of a resource of the agricultural plant in the current time interval by means of at least one metering device, determining a resource consumption per one or more of the operating parameters, and outputting a signal comprising the resource consumption per one or more operating parameters.

The invention is based, among other things, on the recognition that the resource consumption of agricultural operations usually strongly depends on the current operating parameters, like for example the number of animals currently present in a barn of a certain size. The significance of resource consumption of an entire agricultural plant, individual barns, or individual consumers of the system is therefore low and these consumptions are difficult to assess. Another problem in agricultural plants is that boundary conditions such as high loads of ammonia and/or dust prevail, which complicate the use of sensors for a plurality of consumers and/or make it more expensive. Therefore, most often not all consumers in an agricultural plant are equipped with sensors for capturing resource consumption and only information about the total resource consumption of an agricultural plant or a part thereof is available.

The method according to the invention therefore provides to also determine certain agriculture-specific operating parameters, in addition to the resource consumption of consumers of at least one resource, such as electricity, water, gas, or oil, in a certain time interval, for example, one second, one minute, one quarter of an hour, an hour, a period of several hours, a day, a week, a month, or a year.

Determining may, for example, be understood as capturing by means of metering devices or reading from other systems. In addition, the capturing may also comprise a storage of the data captured. The agriculture-specific operating parameters to be determined according to the invention comprise at least information on animal population, structure and climate of the agricultural plant, namely the number of animals, the number and size of the barns, and the temperature inside of the agricultural plant or inside of the barns. By determining the consumption of resources per one of the operating parameters or several of these operating parameters, and outputting the corresponding signal, it is possible for a farmer to obtain transparent and useful information on the resource consumption of the agricultural plant based on its essential, and over time highly variable, operating parameters. This is of great importance in particular for livestock processing businesses working cyclically or in phases or passes, such as chicken or pig farms, since the evaluation of resource consumption during a period depends critically on how many animals are present during this period in the agricultural plant. In this way, for example, power consumption costs for fattening pigs may be determined.

By outputting an appropriate signal, this information is available and usable for a farmer, for example, by the transmission to a graphical user interface, in particular to a display, to a peripheral device, for example a printer or an external storage device, or for transmission to consumer controls, control devices, and/or further external systems or devices.

The at least one metering device with which the resource consumption of at least one consumer may be determined may in a simple case be a central metering device for the entire plant or a part thereof, for example, a central electric meter per plant or per barn.

Alternatively or additionally, the at least one metering device may be, for example, a sensor, a consumer control, or a regulating device. Consumer controls are used for the triggering of one or more consumers. One or more consumer controls may be assigned to a regulating device, and the corresponding regulating device may, for example, be designed as a climate control system that sends higher-level control or regulating signals to the consumer controls.

Also, several of the time intervals exemplified above may be summarized in a period, wherein such a period preferably corresponds to one or more production phases, for example, a fattening period. If several time intervals are combined into a period and this period corresponds to a fattening period, then, for example, the power consumption costs per fattened pig and pig fattening cycle may be determined for an agricultural plant.

When a power consumption is determined as resource consumption, it is particularly preferred that the power consumption is calculated separately for active, reactive, and apparent power and is preferably available as separate power components for a display and/or analysis. This division allows for a more precise capturing and thus a better basis for assessment and/or follow-up measures.

It is preferred that, in addition to the number of animals, the information on the animal population also comprises one or more of the following items of information: type of animals; the average age of the animals; average weight of the animals; production phase; sex of the animals; whereabouts of the animals within the agricultural plant; quantity of animal products, such as eggs, milk, or feces.

It is further preferred that, in addition to the number and size of barns, the data on the physical structure of the agricultural plant comprises one or more of the following items of information: the number of sections; bays per barn; size of sections; bays; and/or number of animals per barn, section, and/or bay.

The information on the structure of agricultural plant may also comprise information on the special technical equipment of the resource consumer, for example, the type and/or number of resource-consuming devices per section and/or per barn. As a result, consumption data between barns, for example, may be better compared if, for example, a first barn has three fans and another barn has six fans.

The information regarding the climate preferably contains further climate data from inside the agricultural plant and/or climate data from outside the agricultural plant, in addition to the temperature inside the agriculture plant. One or more of the items of information regarding the climate are preferably captured by means of one or more sensors and/or are received via interfaces, for example to a weather service. The climate data inside of the agricultural plant may, in addition to the indoor temperature, also comprise, for example, indoor humidity, indoor air pressure, indoor air circulation, and/or indoor light intensity. The climate data outside of the agricultural plant may preferably comprise outdoor temperature, outdoor humidity, wind force, wind direction, and/or outdoor air pressure.

The operating parameters further preferably contain information on applications, comprising feeding, climate control, milking, and/or cleaning, for example, removing manure and/or a change in fattening cycle. Such applications are typical, mostly time-dependent applications in an agricultural plant that may have a significant impact on resource consumption and also depend on the other operating parameters, in particular animal population, structure, and climate. Their detection therefore improves the quality of the results and their further re-usability in a preferred way. The information regarding feeding may contain, for example, information on the type of feed (e.g., dry or liquid) and/or the feeding method (for example transport by conveyor belts) and is available preferably based on the structure of the agricultural plant, in particular, per barn and/or per section.

It is further preferred that the operating parameter contain information about the task, comprising dosing, mixing, distributing, and/or heating. These specific tasks or functions are associated with the activity of consumers, for example, a metering pump, a stirrer, a conveyor belt, an auger, a fan, a vent valve, and/or a heater. Preferably, the information about the tasks is also determined with regard to the structure of the agricultural plant, meaning per barn and/or per section. The detailed determination of operating parameters with regard to the tasks at an agricultural plant in a time interval improves the quality of the results and further processability and readability and is particularly advantageous when the consumers are to be controlled via their tasks, based on the data obtained.

It is further preferable that rate information from resource providers be obtained and/or stored, so that the cost of resource consumption may be determined, displayed, and/or analyzed.

The method may preferably be defined further by the steps of transmitting the signal to at least one consumer control and/or controlling at least one consumer based on the signal.

In this embodiment, the signal is used to change the power of one or more consumers based on the signal, for example, to turn a consumer on or off or to raise or reduce the power consumption of a consumer.

It is preferred in another advantageous embodiment that one or more items of information regarding the animal population are obtained by means of an apparatus for automatically capturing animal-specific data.

Particular advantages may be achieved if one or more of the operating parameters, in particular the information on the animal population, can be read and/or automatically captured from other systems. To this end, provisions are made in this further embodiment for an apparatus for automatically capturing animal-specific data. An apparatus for automatically capturing animal-specific data may be, for example, a counting apparatus, with which the number of animals may be captured, for example, by means of a photocell, a video monitor, or the reading of codes arranged on the animals, for example in the form of a chip. Further examples of apparatuses for automatically capturing animal-specific data are apparatuses for weighing of the excreta of animals, for example, the manure evacuated on a conveyor belt or egg counting devices for capturing the number of eggs produced, for example, in a barn or a section, or a device for determining the individual or average weight of the animals, for example, by means of scale with an animal identification device, arranged at a feed station.

Another preferred further embodiment of the method is characterized by the steps of comparing one or more of the operating parameters determined for the current time interval with operating parameters determined for earlier time intervals, and selecting an earlier time interval as the reference time interval, whose operating parameters have the highest correspondence rate with one or more of the operating parameters determined for the current time interval.

In this further embodiment, the current operating parameters are compared to the historical data. This results in the particular advantage that it may be used as a reference to such earlier time intervals that correspond particularly well in one or more operating parameters with the current time interval. For example, it is possible to draw on a reference time interval, in which a similar number of animals per barn or section were present at a similar indoor temperature of the barn. In this way, it is ensured that a comparison of the resource consumption of the current time interval with an earlier time interval takes place, in which in the earlier time interval production conditions are similar to those in the current time interval, for example, barns with or without full stocking rate and with a certain temperature.

It is further preferred that an earlier time interval based on the historical data of a different agricultural plant is selected as the reference time interval, which corresponds especially well in one or more operating parameters of the current time interval. This has the advantage that it may be chosen from a larger pool of historical data. To this end, it is preferable that the data of different agricultural plants are transmitted to a central data register and may be stored there and retrieved from there. Preferably, the data in the central data register may be anonymous.

Use of data from such a central data register may provide guidance for the farmer, whether the resource consumption compared to other agricultural systems with similar operating parameters (e.g., fattening house with 1,000 animals) is in the average range or if there is a great deviation from it.

Furthermore, a further embodiment of the method with the following steps is preferred by determining one or more forecast operating parameters for a future time interval, comparing of the forecast operating parameter(s) for the future time interval with operating parameters determined for earlier time intervals, selecting an earlier time interval as the reference time interval, whose operating parameters have the highest correspondence level with the forecast operating parameter(s) and the future time interval, and determining a forecast of the resource consumption of the future time interval based on the resource consumption of the reference time interval.

In this further embodiment, the historical data will not only be used for a comparison with the current time interval, but the forecast or prediction of one or more future time intervals.

Here, too, a central data register is of advantage, since in this way, by resorting to data from other agricultural businesses, forecast data may also be determined if the specific agricultural plant has no or only insufficient historical data available.

For the creation of such a forecast, it is basically a first possibility to select a reference time interval based on the operating parameters determined for the current time interval on the basis of the before mentioned further embodiment and to use the data of the earlier time interval, which follows the reference time interval as forecast for the future time interval, which follows the current time interval.

In a further-developed version of the mentioned further embodiment here, one or more forecast operating parameters for a future time interval are determined initially. This may be implemented, for example, particularly in regards to the climate data, by reading data of forecasts from external services, for example weather forecasts. In terms of the operating parameters regarding the animal population, empirical values or planning data, for example, may be used as forecast operating parameters. Furthermore, forecast operating parameters may also be determined from historical data, by choosing the next earlier time interval following this reference time interval based on the reference interval corresponding with the current time interval and the operating parameters obtained in this time interval are used as forecast operating parameter, as described above.

These forecast operating parameters are again compared with operating parameters determined for earlier time intervals and a reference time interval with particularly good correspondence level is selected. The resource consumption of this reference time interval may then be used as forecast for the future time interval.

In this way, much better forecasts for the resource consumption of an agricultural plant are possible because the specific conditions of production of the current or a future time interval are considered.

The steps for creating a forecast may also be performed for several different forecasts in the sense of a simulation of different scenarios or conditions. In this way, future consumption may be simulated under different production conditions, for example to simulate weather conditions that are further in the future and non-predictable or difficult to predict. Therefore, when here or in the following, a forecast or prognostic data is mentioned, the respective characteristics and advantages are particularly also transferable to several forecasts for different scenarios in the sense of a simulation.

In another preferred further embodiment, it is provided, that the determining of the resource consumption of at least one resource type of the agricultural plant comprises the determining of the total resources consumption of at least one resource type of the agricultural plant, preferably by means of a central sensor at a central resource supply of the agricultural plant.

In this further embodiment the total resource consumption of at least one resource type, so, for example, the total power consumption of the agricultural plant, is determined, for example, via a central power meter.

Alternatively or additionally, it is possible to determine the resource consumption of at least one resource type per structural unit of the agricultural plant, so, for example, per barn and/or per section, preferably also by means of sensors that detect the resource consumption for at least one resource type for a barn or a section.

Together with the operating parameters, this results in valuable information, whereby the detection of the resource consumption is very easy, as it is possible to detect the total resource consumptions of the entire agricultural plant or parts thereof by means of central sensors, like, for example, power meters.

In another preferred further embodiment, it is provided, that the determining of the resource consumption of at least one resource type of the agricultural plant comprises the determining of the resources consumption of several consumers of at least one resource type of the agricultural plant, wherein preferably one or more consumers have respectively been assigned one location within the structure of the agricultural plant.

This further embodiment provides that the resource consumption of one or more consumers of at least one resource type is determined, preferably decentralized. In this way, a very exact picture of the consumers responsible for one total resource consumption may be generated. In particular, consumers that are active at certain times, particularly at certain time intervals with peak consumption, may be identified. Here it is particularly preferred that a location within the structure of the agricultural plant is assigned to one or several consumers, for example, a barn and/or a section or, where appropriate, a more detailed site-specific differentiation. Furthermore, it is particularly preferred that one or more of the consumers of an application and/or a function and/or a unit is/are assigned to the structure of the agricultural plant.

Another preferred embodiment of the method is characterized by the step of comparing the determined or predicted resource consumption with a predetermined threshold value and determining a deviation value, and preferably issuing a warning if the calculated or predicted resource consumption falls above or below a predetermined threshold value.

Through comparing threshold values, as provided in this embodiment, peak consumptions may be determined and may, for example, be coupled to a warning signal. While exceeding a certain maximum threshold value may be used in particular for avoiding peak consumptions, exceeding minimum threshold values may, for example, indicate the failure of important consumers or a plurality of consumers and thus troubleshooting may be started early on.

Particularly preferred is the step of specifying the predetermined threshold value based on the operating parameters, wherein preferably a recommendation for the predetermined threshold value is determined, and wherein preferably the recommendation may be displayed, confirmed, or changed by a user.

It is provided in this preferred embodiment that the predetermined threshold value, to which the determined or predicted resource consumption is compared to, changes with the operating parameters. Thus, for example, the threshold value for a power consumption in mild temperatures and a fully occupied barn may be set lower than with especially low temperatures and only few animals in the barn. A recommendation for the threshold value may, for example, be determined from historical data by, for example, choosing the resource consumption of an earlier time interval as a recommendation, where on the one hand, a high correspondence level between the operating parameters of the current time interval and the operating parameters of the earlier time interval is given and at the same time an especially low or average resource consumption was determined compared to other earlier time intervals with similarly high correspondence levels of the operating parameter. Preferably, a recommendation for a predetermined threshold value, independent of how it was determined, may be displayed for a user and may also be changed, if appropriate. The threshold value may also, for example, be set by a user. Furthermore, the threshold value may also be specified and/or changed, for example, based on rates of resource suppliers.

It is in particular also preferred to set at least two different threshold values, so that the analysis and, if appropriate, the display of a warning may be in the form of a traffic light.

It is further preferred to determine and/or output the resource consumption and/or the deviation value of one or more operating parameters separately.

Another preferred embodiment of the method is characterized by the step of setting and, if appropriate, outputting the resource consumption and/or the deviation value of several time intervals in one time period, wherein preferably only time intervals are shown or highlighted in which the resource consumption and/or the deviation value exceed the maximum or minimum value of a predetermined threshold value.

This further embodiment presents a preferred example for an analysis of the resource consumption in which the resource consumption is presented across several time intervals. It is possible to display, for example, the changes of the operating parameters during this time period in addition to the pattern of the resource consumption during this time period. It is especially preferred, for example, to only show and/or highlight those time intervals (or hide other time intervals) in which the resource consumption or the deviation value exceed the maximum or minimum value of a predetermined threshold, which may be identical to or different from the threshold value mentioned above. Such a display mode makes it easier for a user to quickly recognize time intervals, in which the maximum or minimum value of the predetermined threshold is exceeded and thus results in a particularly fast overview.

In doing so, the step of setting and outputting the consumers and/or operating parameters active in one or more time intervals is further preferred. Especially if such a display not only shows the resource consumption during these chosen time intervals but, for example, also shows the active consumers and the respective operating parameters, conclusions about the reasons for the peak consumptions may be drawn quickly.

Furthermore, an embodiment is preferred that is characterized by the step of triggering at least one consumer control and/or control system based on the determined and/or predicted resource consumption and/or the deviation value.

In this further embodiment, the determined and/or the predicted resource consumption and/or the deviation value is utilized to regulate the activation of the consumer. For example, consumers may be activated or deactivated based on the total resource consumption of the agricultural plant or a part thereof, or their power consumption may be decreased or increased. Preferably, the operating parameters are also considered for triggering, so that in particular those consumers are triggered that require an activation or deactivation or a change in power consumption or that allow an appropriate adjustment without negative impact on the operating parameters, in particular the animals.

The step of triggering at least one consumer control and/or one control system based on a prioritization of the consumer is especially preferred, wherein the prioritization preferably comprises information about a time delay for triggering and/or information about a minimum and/or maximum duration of a curtailment.

The triggering of the consumers via consumer controls or control systems preferably takes place through a prioritization. This prioritization specifies, for example, the delay with which a consumer is activated and/or deactivated after the predetermined maximum or minimum value of the threshold of the resource consumption was exceeded. Furthermore, minimum and/or maximum durations for the deactivation or turning down of a consumer may be lodged in the prioritization.

The step of setting of the prioritization of a consumer based on the time interval or the operating parameters is further especially preferred.

It is especially preferred when the prioritization of one or more consumers is variable and is changed based on the time interval and/or the operating parameters. For example, the consumers that are active in connection with feeding at set times of the day may have an especially high prioritization or the climate control during production phases with very young piglets may be prioritized higher than in production phases with older, more robust young animals.

Further preferred is the step of determining tolerance ranges, within which a control system may trigger one or more consumer controls based on the time interval, the determined and/or predicted resource consumption, the resource consumption specific to agriculture, and/or the deviation value.

This variant is particularly advantageous, for example, at feeding times or for climate control. The climate regulation, for example, to maintain a certain temperature in the agricultural plant or a part thereof may, for example, have a tolerance range of a few degrees around a preferred temperature value. For example, to save electricity during peak consumption, a control system may then, for example, trigger a consumer control in such a way that the agricultural plant or a part thereof is only heated to a temperature value at the bottom of the tolerance range. The tolerance ranges, in turn, may preferably vary with the time interval and/or the operating parameters. For example, a temperature tolerance range in production phases with very young piglets may be less than a temperature tolerance range in a production phases with older, more robust young animals. Fixed feeding times may be provided with time tolerances so that, for example, to avoid or reduce peak consumption, the feeding time (and the associated activity of consumers) may be moved forward or backward in a certain time window predetermined by the time tolerances.

In another preferred embodiment, it is provided that one or more resource source is determined for at least one resource type. This way the analysis of the resource consumption may be extended to include the resource source from which the consumed resource that was purchased.

Furthermore, it is preferable to control the purchase of resources from different resource sources based on the determined and/or predicted resource consumption, the time interval, the operating parameters, and/or the deviation value. It is particularly preferred to activate resource sources that are not available at other times at specific times, for example solar systems. Furthermore, favorable resource sources may be added if other resource sources, for example due to higher rates of resource providers at specific times or above a certain amount, are very expensive. It is particularly preferred if alternative energy sources, for example biogas plants, solar panels, wind turbines, or decentralized energy sources, such as generators, may be trigged as a selectable resource sources.

Further preferred is the step of displaying planned and/or predicted operating parameters for one or more time intervals. Such a central and/or remote display, preferably together with predicted resource consumptions, allows a quick and detailed overview of the planned future production in the agricultural plant and the expected associated resource consumption. Also preferred is the step of offering the possibility to a user to change one or more of the operating parameters, particularly the beginning, end, and/or duration of applications.

According to a further aspect of the invention, the above-mentioned objects are achieved by a system for monitoring and/or controlling of the resource consumption of an agricultural plant for livestock farming and rearing, in particular a livestock production operation, by performing a method according to any one of the preceding objects, comprising a time capturing unit for determining a time interval, a detection unit for determining agriculture-specific operating parameters of the agricultural plant in a current time interval, wherein the operating parameters include information concerning animal population (namely the number of animals), structure (namely the number and size of barns of the agricultural plant), and climate (namely the temperature inside the agricultural plant), at least one metering device for determining a resource consumption of at least one consumer of at least one resource type of the agricultural plant in the current time interval, a computing unit for determining resource consumption per one or more of the operating parameters, an output unit for outputting a detected signal from the computing unit comprising the resource consumption per one or more of the operating parameters.

The system may preferably further have climate sensors and/or interfaces to external systems, for example a weather service and/or interfaces to other systems to read out operating parameters and/or other data.

Further, the system may comprise display devices, such as Graphical User Interfaces (GUI), peripherals, or other devices and/or interfaces to such devices. The system may be configured as a decentralized system having a plurality of decentralized processing units communicating with each other or as a central system having a central processing unit, which is connected to decentralized metering devices, such as the at least one consumer metering device. In particular, the system may be advanced by an apparatus for automatically capturing animal-specific data, namely one or more items of information regarding animal population.

The system according to the invention and its further embodiments preferably feature characteristics that render the system and its further embodiments particularly suitable to be used in a method according to the invention and its further embodiments. In regard to the advantages, versions of embodiments, and embodiment details of the system and its further embodiments, reference is made to the above description in regard to the corresponding features of the method.

### BRIEF DESCRIPTION OF THE DRAWINGS

The invention is described hereinafter by way of example with reference to the exemplary embodiments shown in the figures. It is shown in:

FIG. 1 is a schematic view of a first example of an agricultural plant equipped with a central consumer metering device;

FIG. 2is a schematic view of another example of an agricultural plant equipped with several consumer metering devices;

FIG. 3is a schematic via of an example of an agricultural plant equipped with several consumer metering devices and several consumer controls or control systems;

FIG. 4 is a schematic view of a general overview of an example of a system for monitoring and/or controlling the resource consumption of an agricultural plant.

FIGS. 5-8 are different display and analysis examples of data determined with a method and/or system according to the invention;

FIG. 9 is a timeline view of an example for two different prioritizations and the respective triggering of the consumers; and

FIG. 10 is a view of an example of a combined display of the resource consumption with two threshold values as well as the statuses of the overall system as well as various consumer controls or control systems.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1 to 3 show various examples by means of which kind of infrastructure the resource consumption, here the power consumption, of an agricultural plant 1 with four barns 1a, 1b, 1c, 1d can be captured. The four barns 1a, 1b, 1c, 1d of the agricultural plant 1 have switch box 2a, 2b, 2c, 2d assigned to them, respectively, which are connected to a central power supply 4 by a power cable 3. A network connection to a computing unit 5′ is established via a network connection 5.

The examples shown in FIGS. 1 to 3 differ in the number and arrangement of the metering devices. In FIG. 1, the total resource consumption of the agricultural system 1, here the total power consumption, is captured by means of a central sensor 6, here a central power meter, at the central power supply 4.

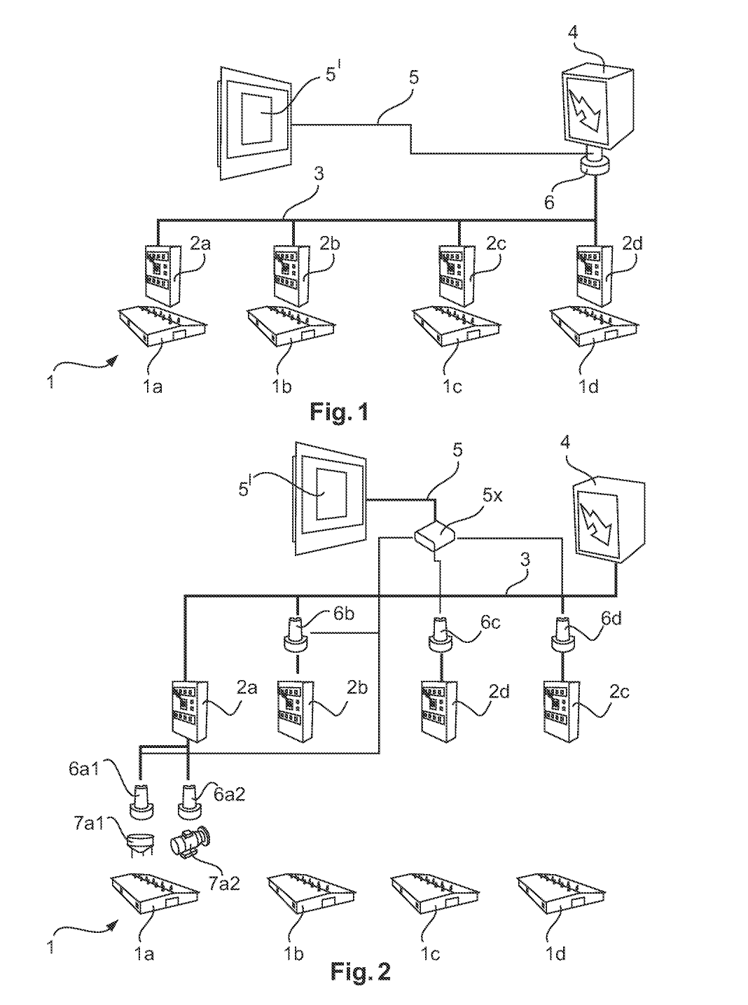

In the example shown in FIG. 2, central metering devices 6b, 6c, 6d are provided for the barns 1b, 1c, 1d, respectively. Further shown in barn 1a of the agricultural plant 1 of FIG. 2 are two consumers 7a1, 7a2, which have a metering device 6a1, 6a2 directly assigned to them respectively. All metering devices 6a1, 6a2, 6b, 6c, 6d are integrated in a network via a sensor box 5x and the Ethernet connection 5.

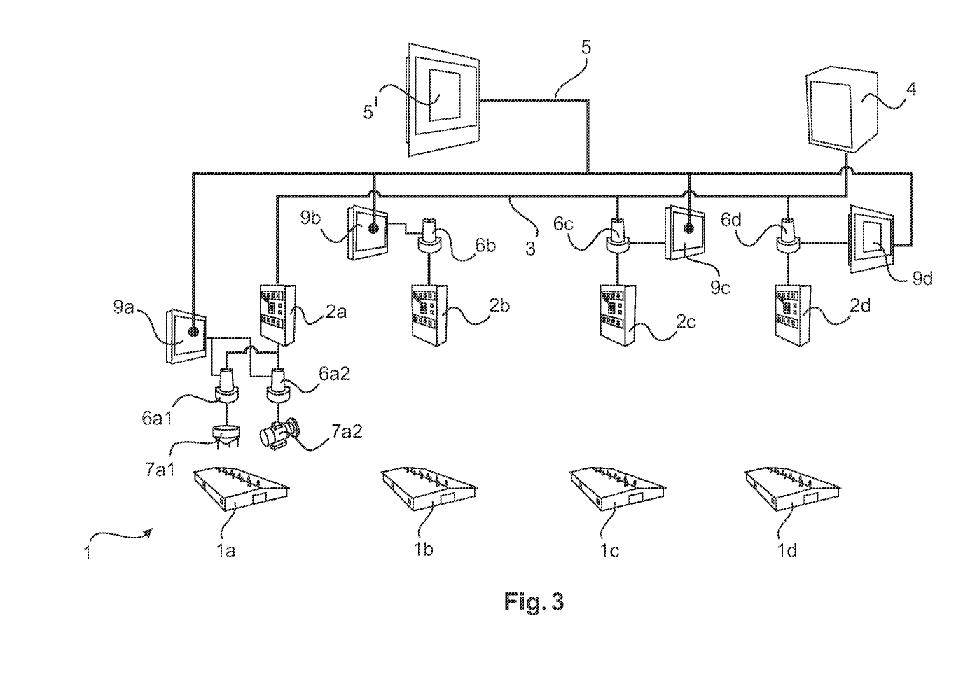

In FIG. 3, the barns 1b, 1c, 1d also have a central metering device 6b, 6c, 6d, assigned to them, respectively, while in barn la sensors 6a1, 6a2 are assigned to specific consumers 7a1, 7a2. Additionally, consumer controls or control systems 9a, 9b, 9c, 9d are provided in FIG. 3, via which the metering devices 6a1, 6a2, 6b, 6c, 6d are integrated into a network via a network connection 5.

A central sensor box 5x is provided only in FIG. 2 of the examples shown but may be used also in the examples of FIGS. 1 and 3. Conversely, the metering devices may also be connected directly to a network without a sensor box in a constellation according to FIG. 2. Similarly, the examples with consumer controls or control devices shown in FIGS. 1 and 2 may be used according to the example shown in FIG. 3.

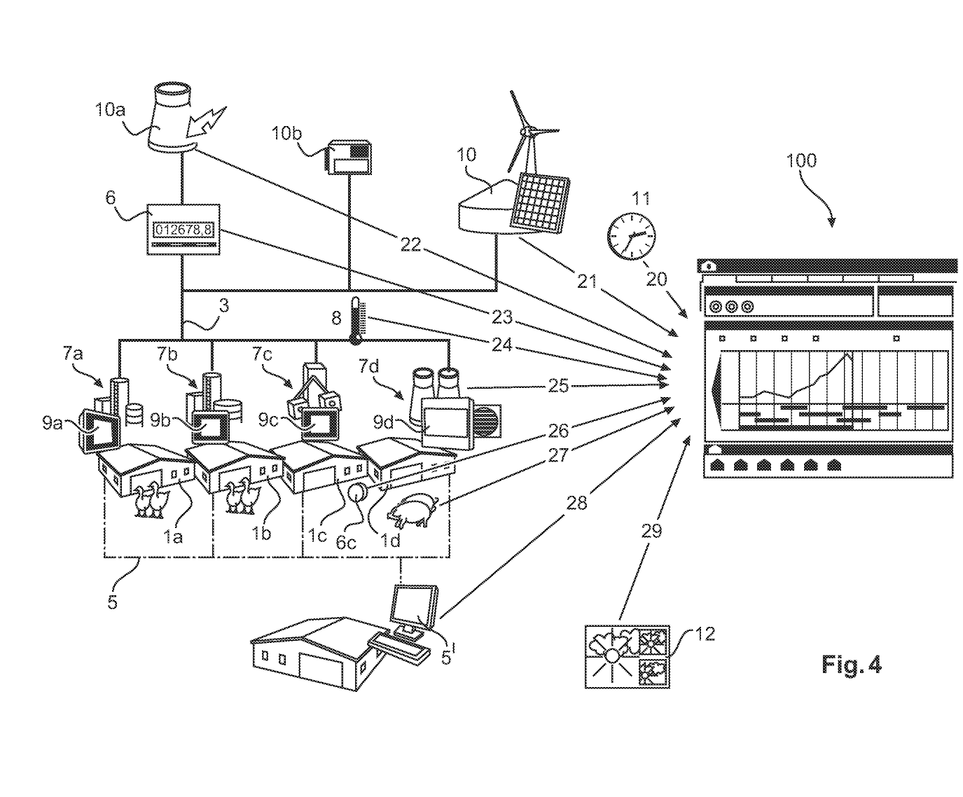

In FIG. 4, a general overview of an example of a system for monitoring and/or controlling the resource consumption of an agricultural plant is shown. The agricultural plant 1 of the example shown in FIG. 4 also has 4 barns 1a, 1b, 1c, 1d. The two barns 1a, 1b are for fattening chickens and/or egg production and the barns 1c, 1d are for raising piglets and/or fattening hogs and/or keeping sows. The barns 1a, 1b, 1c, 1d have the consumers 7a, 7b, 7c, 7d, as well as consumer controls or control systems 9a, 9b, 9c, 9d assigned to them, respectively. For the sake of clarity, a metering device 6c is only shown for barn 1c, however, the other barns may have one or more metering devices as well. Furthermore, one or more sensors 8 for capturing operating parameters, here information about the climate within the agricultural system 1, are provided.

The consumer controls or control systems 9a, 9b, 9c, 9d are integrated into a network and connected to a central computing unit 5′ via a network connection 5. The consumers 7a, 7b, 7c, 7d are connected to a main resource source, here a power supplier 10a, with a power supply line 3 via a central metering device 6.

In this example, further resource sources are a generator 10b as well as one or more alternative energy sources such as biogas plants, solar panels and/or wind turbines 10c. Preferably, the resource consumption may be captured separately for each resource source. It is further preferred, that energy sources 10a, 10b, 10c may be selected automatically or by a user, based on resource consumption and/or operating parameters and/or time intervals.

The system further has a time capturing unit 11 and an interface 12 to external services, like for example a weather service.

The named elements of the system determine a plurality of data or items of information. These are in particular time intervals 20, information 21 about the service generated by the resource sources 10c, rate information 22 about the rates of central energy suppliers 10a, information 23 about the total resource consumption from the central metering device 6, climate data 24 from the sensors 8, resource consumptions 25, for example, the consumer 7d, barn-related resource consumptions 26, for example from barn 1c, operating information 27, here information regarding animal population that are preferably determined by means of an apparatus for automatically capturing animal-specific data, historical data 28, particularly on resource consumptions and operating parameters of earlier time intervals, which are preferably stored in a memory unit of the computing unit 5′, as well as data 29 from an external service, for example weather data.

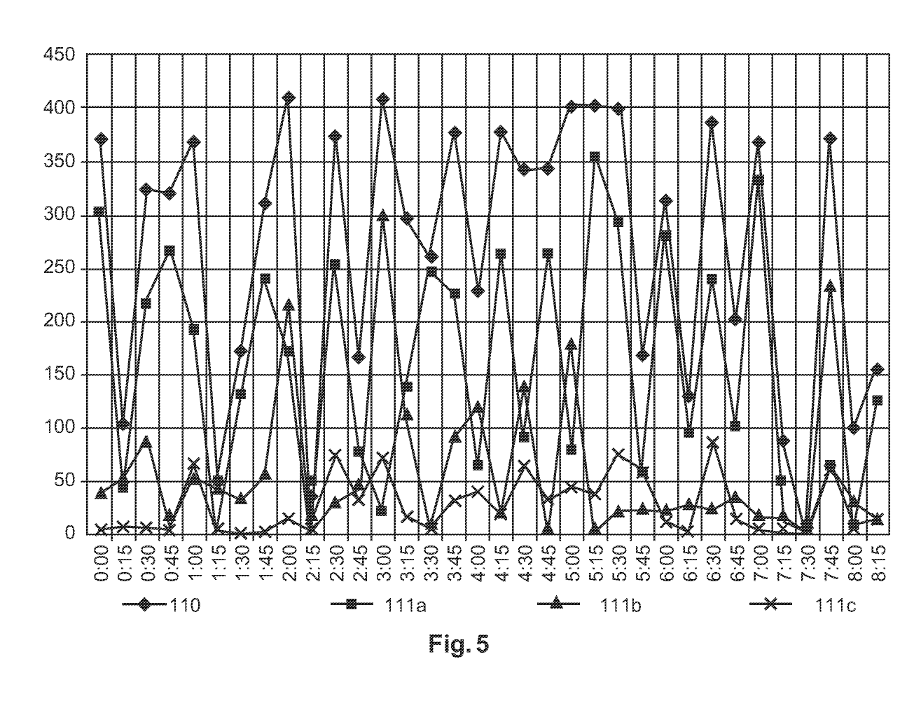

After being determined and analyzed, these items of information may be displayed by means of a display 100. Examples for possible analyses and their display are shown in FIGS. 5 to 8.

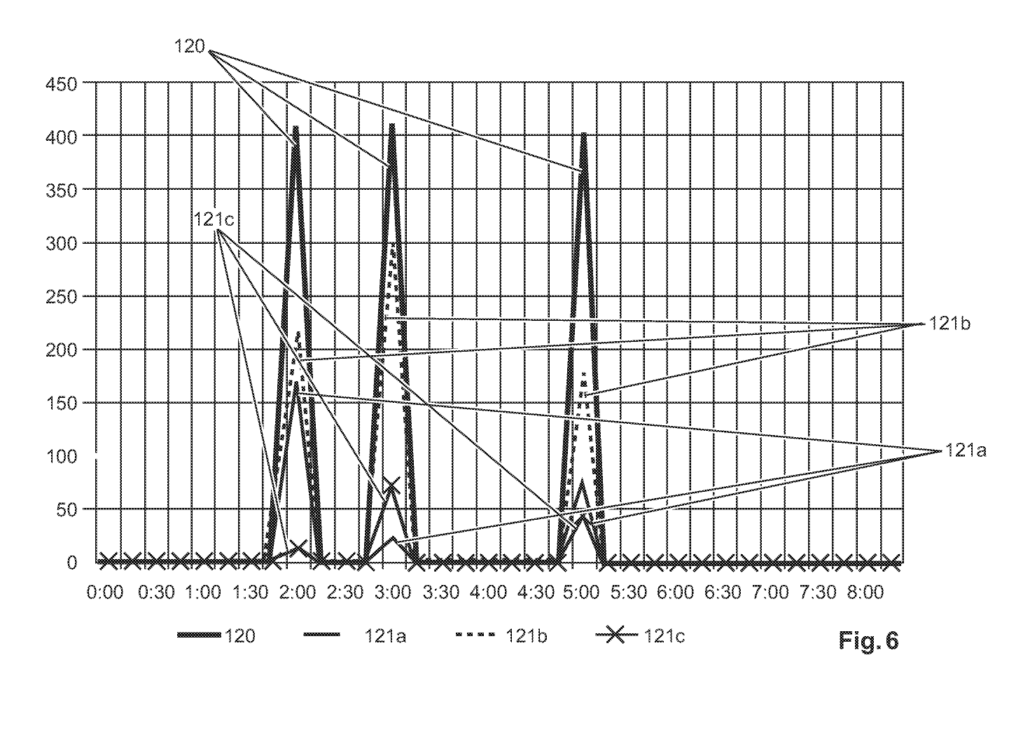

FIG. 5 shows the resource consumption in kilowatt (kW) on the vertical axis and 15-minute time intervals on the horizontal axis. The line 110 shows the total resource consumption, line 111a the resource consumption of a first barn, line 111b the resource consumption of a second barn and line 111c the resource consumption of a third barn. FIG. 6 likewise shows 15-minute time intervals on the horizontal axis and resource consumptions in kW on the vertical axis, however in this illustration the resource consumptions are only displayed for such time intervals, in which the resource consumption exceeds a certain threshold value, here 400 kW. Line 120 indicates the total resource consumption, line 121a the resource consumption in a first barn, line 121b the resource consumption in a second barn and line 121c the resource consumption in third barn.

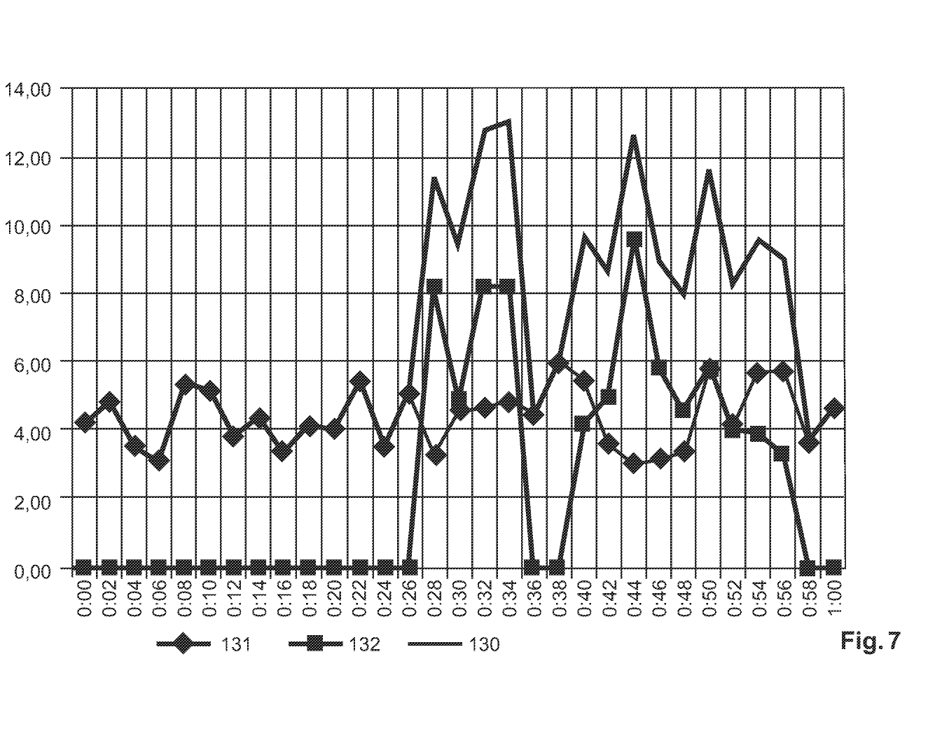

In FIG. 7, the time is plotted in 2-minute time intervals on the horizontal axis and the resource consumption in kW on the vertical axis. As shown in FIG. 7, the total resource consumption is indicated with line 130 and this resource consumption is additionally divided according to two different applications, namely climate control 131 and feeding 132. This way it becomes clearly apparent, for example, that the total resource consumptions 130 climbs significantly at the start of feeding 132 and falls again after the feeding ended.

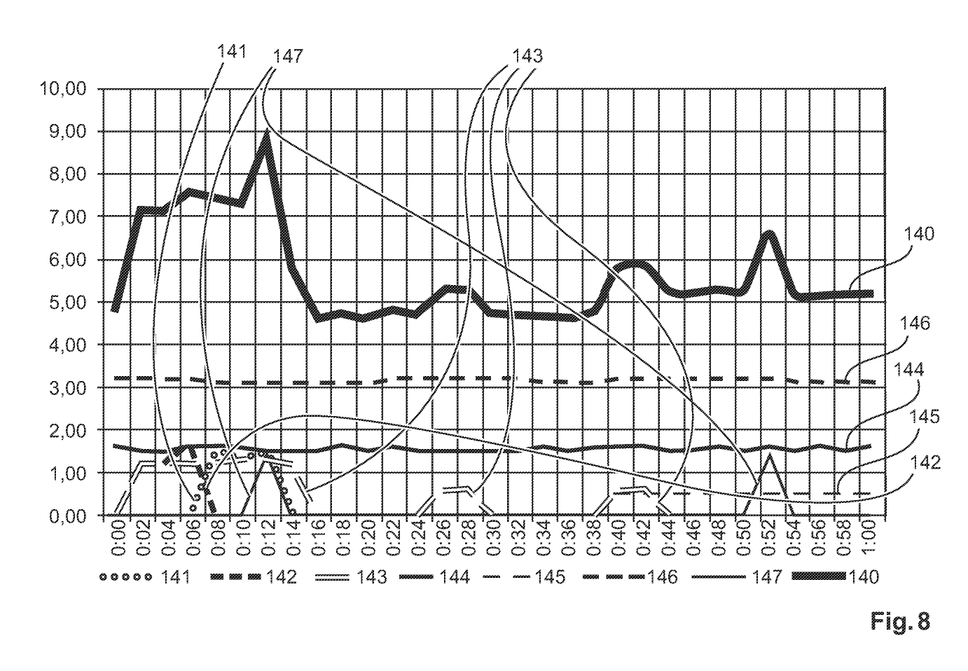

FIG. 8 also shows 2-minute time intervals on the horizontal axis and the resource consumption in kW on the vertical axis. In this illustration the total resource consumption 140 is shown divided according to the individual consumers for the tasks of the active application, namely two feed conveyors 141, 142, one mixer 143, two fans 144, 145, one heater 146 as well as one motorized winch 147.

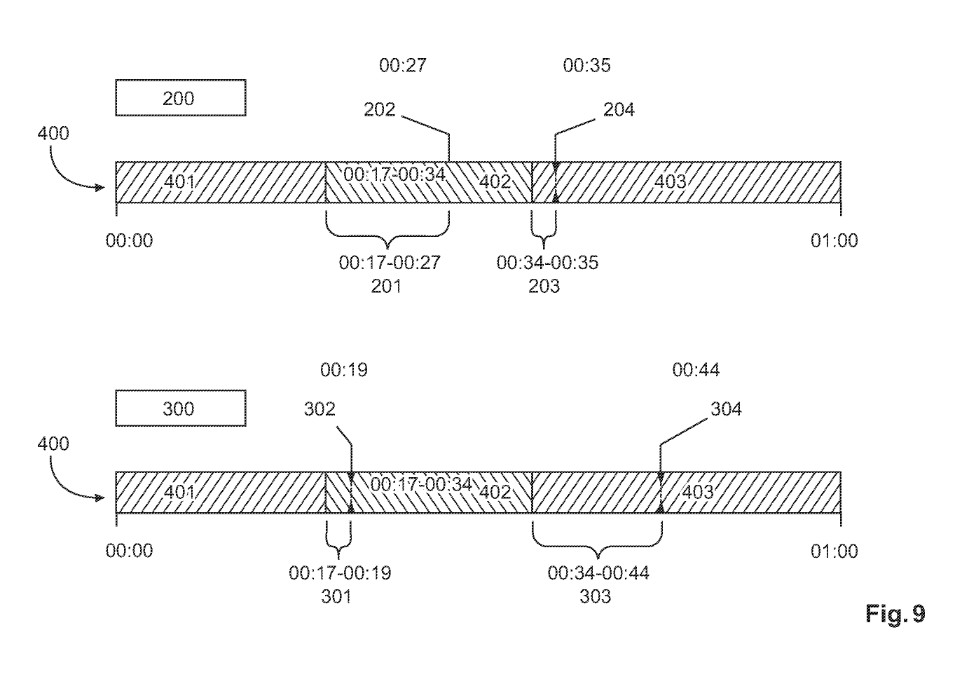

In FIG. 9, different prioritizations for different consumers are shown. Especially when the determined results and evaluations are to be used for a consumer control, it is advantageous if the consumer can be assigned to different prioritizations in order to achieve better consumer control. In the example shown in FIG. 9, an important consumer is indicated with 200, and a less important consumer with 300. A resource consumption or a deviation value from a threshold value of this resource consumption that is present at a particular time is indicated with 400. The resource consumption in sections 401 and 403 is uncritical, no threshold value is exceeded. In section 402, on the other hand, a predetermined threshold value of the resource consumption is exceeded, so that a warning is outputted. Consequently, a triggering of the consumer shall take place in those sections 402 to reduce the resource consumption.

The prioritizations 200 and 300 now define the time delay 201, 301, with which the consumers are to be deactivated or their power consumption is to be reduced, after the exceeding of the threshold value occurs and the time delay 203, 303, with which the consumers are to be activated again or their power consumption is to be raised again following the end of the exceeding of the threshold value. As can be seen in FIG. 9, the time delay 201 is markedly longer with a higher prioritization 200, than the corresponding time delay 301 with a lower prioritization 300. Conversely, the time delay 203, until the consumer is fully activated again, is markedly lower with higher prioritization 200, than the corresponding time delay 303 with lower prioritization 300. Thus, the consumer with the higher prioritization 200 is first deactivated at the instance 202 and already activated again at instance 204 with just a short time delay 203 following the end of the exceeding of the threshold. The consumer with the lower prioritization 300 is already deactivated or reduced in its power consumption at the instance 302, after a short time delay 301, and first activated again at instance 304 with a longer time delay 303 following the end of the exceeding of the threshold value.

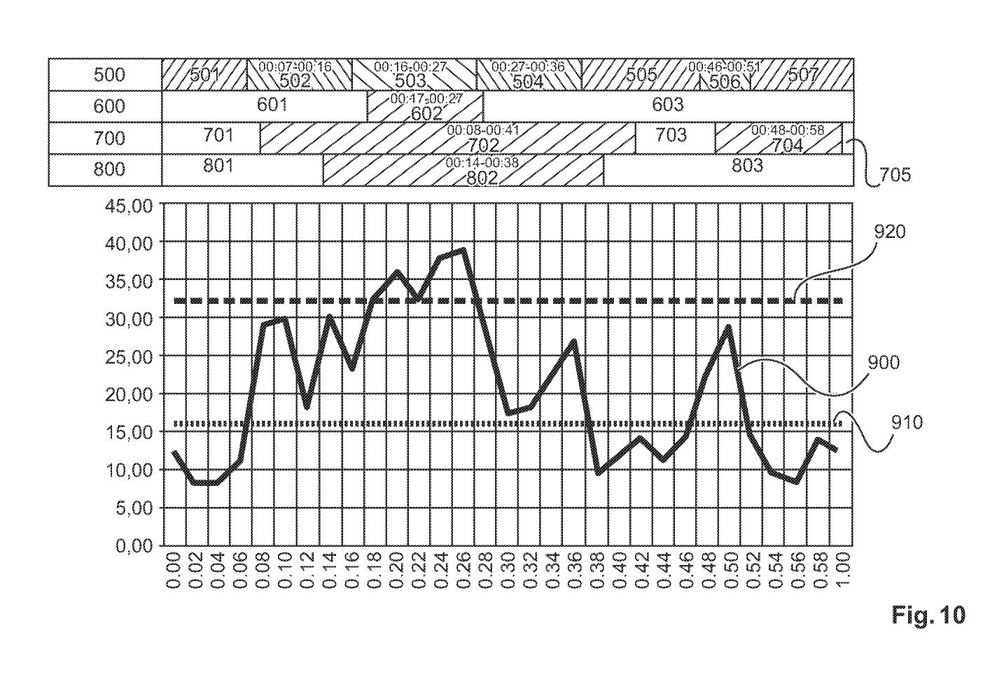

FIG. 10 shows an analysis and display example, in which 2-minute time intervals are shown in the lower section on the horizontal axis and the resource consumption is plotted on the vertical axis. A first predetermined threshold value is illustrated with 910, a second predetermined threshold value with 920. The total resource consumption 900 is partially below the first threshold value 910, partially between the two threshold values 910 and 920 and partially above the second threshold value 920. In the upper section of the illustration in FIG. 10, 500 illustrates the deviation value and thus the exceeding of the threshold value.

In sections 501, 505, and 507 it can be illustrated, for example, by means of traffic light labeling with the color green that the total resource consumption is below the first threshold value 910. In sections 502, 504, and 506 it can be illustrated, for example, by means of traffic light labeling with the color yellow that the total resource consumption 900 is between the two threshold values 910 and 920. In section 503 it can be illustrated, for example, with red labeling that the resource consumption exceeded the second threshold value 920.

In bars 600, 700, and 800 in FIG. 10, further information is provided about the times when certain consumer control or control systems are working within the normal range (here sections 601, 603, 701, 703, 705, 801, and 803) and in which sections (here 602, 702, 704, and 802) the consumer controls or control systems have deactivated the consumers assigned to them or reduced their power. This way, an especially clearly arranged illustration of the resource consumption and the control measures that took place may be obtained.

It is to be understood that variations and modifications can be made on the aforementioned structure and method without departing from the concepts of the present invention, and further it is to be understood that such concepts are intended to be covered by the following claims unless these claims by their language expressly state otherwise.

1.-17. (canceled)

18. A method for monitoring or controlling the resource consumption of an agricultural plant for livestock farming or rearing, in particular of a livestock production business, comprising the steps of:
determining agriculture-specific operating parameters of the agricultural plant in a current time interval, wherein the operating parameters include information concerning animal population, structure, and climate;
determining resource consumption of at least one consumer of at least one type of a resource of the agricultural plant in the current time interval by means of at least one metering device;
determining a resource consumption per one or more of the operating parameters;
outputting a signal comprising the resource consumption per one or more operating parameters.

19. The method of claim 18, wherein the information concerning the animal population is the number of animals, the information concerning the structure is number and size of the barns of the agricultural plant, and the information concerning the climate is a temperature within the agricultural plant.

20. The method according to claim 18, comprising the step of sending the signal to at least one consumer control.

21. The method according to claim 18, comprising the step of triggering of at least one consumer based on the signal.

22. The method according to claim 18, wherein one or more items of information regarding the animal population is obtained by means of an apparatus for automatically capturing animal-specific data.

23. The method according to claim 18 , further comprising by the steps of:
comparing one or more of the operating parameters determined for the current time interval with the operating parameters determined for a plurality of earlier time interval; and
choosing an earlier time interval as a reference time interval, whose operating parameters have the highest correspondence level with one or more operating parameters determined for the current time interval.

24. The method according to claim 18, further comprising the steps of:
setting one or more forecast operating parameters for a future time interval;
comparing the forecast operating parameter(s) determined for the future time interval with the operating parameters determined for one or more earlier time interval(s);
choosing an earlier time interval as a reference time interval, whose operating parameters have the highest correspondence with the forecast operating parameter(s) and for the future time interval; and
determining a forecast of the resource consumption of the future time interval based on the resource consumption of the reference interval.

25. The method according to claim 18, wherein the step of the determining the resource consumption of at least one resource type of the agricultural plant comprises determining the total resources consumption of at least one resource type of the agricultural plant.

26. The method according to claim 25, wherein the step of the determining the resource consumption of at least one resource type of the agricultural plant is determined by means of a central sensor at a central resource supply of the agricultural plant.

27. The method according to claim 18, wherein the step of determining the resource consumption of at least one resource type of the agricultural plant comprises determining the resources consumption of several consumers of at least one resource type of the agricultural plant.

28. The method according to claim 27, wherein one or more consumers have respectively been assigned one location within the structure of the agricultural plant.

29. The method according to claim 18, further comprising the step of comparing the determined or a predicted resource consumption with a predetermined threshold value and determining a deviation value.

30. The method according to claim 29, further comprising the step of issuing a warning if the calculated or predicted resource consumption falls above or below the predetermined threshold value.

31. The method according to claim 29, further comprising the step of specifying the predetermined threshold value based in the operating parameters, wherein a recommendation for the predetermined threshold value is determined, and wherein the recommendation may be displayed, confirmed or changed by a user.

32. The method according to claim 18, further comprising the step of setting and outputting the resource consumption or a deviation value of several time intervals in one time period, wherein only time intervals are shown or highlighted in which the resource consumption or the deviation value exceed a maximum or minimum value of a predetermined threshold value.

33. The method according to claim 18, further comprising the step of setting and outputting of the consumers or operating parameters active in one or more time intervals.

34. The method according to claim 18, further comprising the step of triggering at least one consumer control or control system based on the determined or a predicted resource consumption or a deviation value.

35. The method according to claim 34, further including the step of triggering at least one consumer control or one control system based on a prioritization of the consumer, wherein the prioritization preferably comprises information about a time delay for triggering or information about a minimum or maximum duration of a curtailment.

36. The method according to claim 35, further comprising the step of setting the prioritization of a consumer based on the time interval or the operating parameters.

37. The method according to claim 34, further comprising the step of determining tolerance ranges within which a control system may trigger one or more consumer controls based on any of a time interval, the determined resource consumption, the predicted resource consumption, a resource consumption specific to agriculture, or the deviation value.

38. A system for monitoring or controlling the resource consumption of an agricultural plant for livestock farming and rearing, in particular of a livestock production business, the system comprising:
a time capturing unit for determining a time interval;
a detection unit for determining agriculture-specific operating parameters of the agricultural plant in a current time interval, wherein the operating parameters include information concerning animal population, namely number of animals, structure, namely number and size of barns of the agricultural plant, and climate, namely temperature within the agricultural plant;
at least one metering device for determining a resource consumption of at least one consumer of at least one resource type of the agricultural plant in the current time interval;
a computing unit for setting resource consumption per one or more operating parameters; and
an output unit for outputting a signal determined by the computing unit, comprising the resource consumption per one or more operating parameters.

39. A system according to claim 38, further comprising an apparatus for automatically capturing animal-specific data, namely one or more items of information regarding animal population.
